(19) United States
(12) Patent Application Publication
(10) Pub. No.: US 2020/0025658 A1
(43) Pub. Date: Jan. 23, 2020

(54) RETENTION OF COMPOSITION OF LIQUEFIED NATURAL GAS ON VAPOURISATION

(71) Applicant: JDSE LIMITED, Shrewsbury, Shorpshire (GB)

(72) Inventor: Jeremy KNIGHT, Market Drayton (GB)

(73) Assignee: JDSE Limited, Shrewsbury, Shorpshire (GB)

(21) Appl. No.: 16/498,310

(22) PCT Filed: Mar. 27, 2018
(86) PCT No.: PCT/GB2018/050795

§ 371 Date: Sep. 26, 2019

(30) Foreign Application Priority Data
Mar. 27, 2017 (GB) 1704788.7

(51) Int. Cl. G01N 1/44; G01N 1/20

(52) U.S. Cl. CPC G01N 1/44; G01N 2001/2021; G01N 1/20; G01N 1/2035

(57) ABSTRACT

A method of vapourising a sample of liquefied natural gas so as to retain the proportions of components of the liquefied natural gas on vapourisation, the method comprising the steps of: introducing liquefied natural gas into a liquid inlet (112) of a liquefied natural gas vapouriser (110); vapourising the liquefied natural gas at a vapourisation element (134) of the liquid inlet (112); and directing vapourised liquefied natural gas into a vapourisation conduit portion (120) directly after the liquid inlet, the vapourisation conduit portion (120) having a fall, thereby encouraging vapourised liquid natural gas to be directed against a flow direction of liquid or liquid-gas phase natural gas in the vapourisation conduit portion to encourage remixing of the vapourised liquid natural gas and liquid or liquid-gas phase natural gas A liquefied natural gas vapouriser (110) suitable for the above method is also provided.

The present invention relates to a liquefied natural gas vapouriser, and more particularly but not necessarily exclusively to a liquefied natural gas vapouriser which vaporizes liquefied natural gas for the purpose of sampling and measurement.

Natural gas, whilst predominantly comprised of methane, is a mixture of different gaseous hydrocarbons, typically with a range of boiling points, as well as small percentages of other compounds, and is used as an energy source worldwide. For ease of transport and storage the natural gas is typically liquefied by being cooled to approximately −168° C. It can then be transported in ships, road tankers, and/or pipes to be used, for example, as a fuel source for power stations.

It may be desirable to monitor the composition of liquefied natural gas at transfer points to measure its energy content, calorific value, and other properties. It may also be further desirable to monitor the composition to see that it does not contain unacceptable compounds, such as sulphides or mercury. This monitoring can be achieved by withdrawing a sample of the liquefied natural gas from the pipe, vapourising the sample and then analysing it.

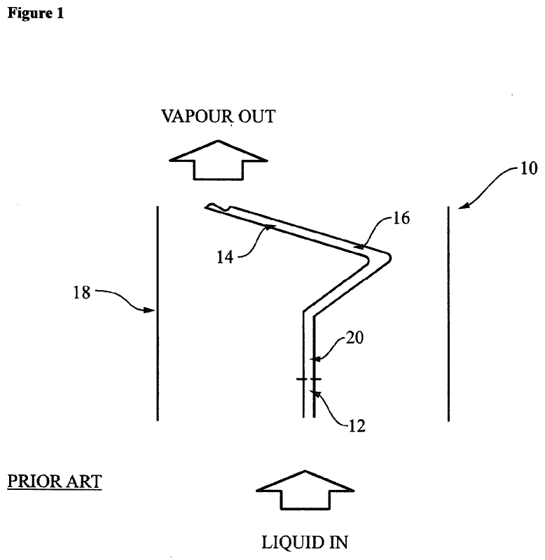

This vapourisation is typically achieved by the sample flowing through a heat exchanger adjacent to a liquefied natural gas sample point. Referring to FIG. 1 there is shown a portion of a conventional liquefied natural gas vapouriser 10, in accordance with the state of the art, where a liquid inlet 12 is below a vapour outlet 14, from which warmed vapour exits the vapouriser 10. In this case, the liquid inlet 12 is positioned directly vertically below the vapour outlet 14.

Sealably connecting opposing ends of the liquid inlet 12 and the vapour outlet 14 together is a fluid transport conduit 16. The liquid inlet 12 extends into a vapouriser housing 18 via a vapourisation conduit portion 20, which in turn extends into a heat exchanger conduit through a majority of the vapouriser housing 18. Vapourisation of the liquefied natural gas occurs in the vapourisation conduit portion 20, which is traditionally positioned vertically or substantially vertically with liquefied natural gas entering into the liquid inlet 12 at the bottom of the vapouriser housing 18. The vapour created on vapourisation, being less dense than the liquefied natural gas, will naturally rise through the heat exchanger conduit 22 towards the vapour outlet 14.

The heat exchanger conduit may take a circuitous path through the vapouriser housing 18, and may be connected to one or more ribbed portions of the vapouriser housing, which may act as a radiator, improving thermalization of the vapour in the heat exchanger conduit.

This arrangement is a standard or traditional configuration for vapourising natural gas, and indeed, other substances. The liquefied natural gas is introduced at the bottom of the liquefied natural gas vapouriser 10, and when the liquefied natural gas is vapourised, the gas naturally rises through the fluid transport conduit 16.

However, undesirable fractionation of the liquefied natural gas sample in the liquefied natural gas vapouriser can occur. In this conventional arrangement, the less volatile components of the liquefied natural gas may not vapourise immediately and, if they fail to do so, fractionation can occur. Volatile vapourised components of the sampled liquid will accelerate away from the liquid phase or liquid-gas phase boundary sample, leaving the less volatile components lagging behind inside the vapouriser 10. Consequently, the analysed components are not necessarily representative of the liquefied natural gas from the pipe, as the fractionation results in altered concentrations of the various fractions at the point of analysis.

The present invention seeks to provide a solution to these problems by encouraging consistency between the source of the liquefied natural gas and the analyte constituent compositions.

According to a first aspect of the invention, there is provided a method of vapourising a sample of liquefied natural gas so as to retain or substantially maintain the proportions of components of the liquefied natural gas on vapourisation, the method comprising the steps of: introducing liquefied natural gas into a liquid inlet of a liquefied natural gas vapouriser; vapourising the liquefied natural gas at a vapourisation element, such as an apertured plate, at or adjacent to the liquid inlet; and directing vapourised liquefied natural gas into a vapourisation conduit portion directly after the liquid inlet, the vapourisation conduit portion having a fall, thereby encouraging vapourised liquid natural gas to be directed against a flow direction of liquid or liquid-gas phase natural gas in the vapourisation conduit portion to encourage remixing of the vapourised liquid natural gas and liquid or liquid-gas phase natural gas.

The provision of a fall after the liquid inlet of the vapouriser allows the more volatile components of the liquefied natural gas, that may vapourise more quickly, to rise under the effect of buoyancy, through oncoming liquid-gas phase natural gas which runs through the vapourisation conduit portion along the fall. Bubbles of the volatile components are thus able to subsequently remix with the liquid or liquid-gas phase components as they travel in opposite directions through the vapourisation conduit portion. This retains or substantially maintains the proportion of the components of the liquefied natural gas in the vapour phase as they were in the liquid phase, and allows for analysis that is or is more representative of the source of the liquefied natural gas taken for the sample.

Preferably, the method may further comprising a further step of passing vapourised liquid natural gas into a heat exchange conduit immediately after the vapourisation conduit portion, in which case a flow path through the heat exchange conduit may follow a circuitous, tortuous or serpentine path through the liquefied natural gas vapouriser.

Following a circuitous, tortuous or serpentine path allows for a greater length of liquefied natural gas vapouriser to be located within a given area. This therefore allows for a more compact arrangement of the liquefied natural gas vapouriser which thereby occupies less space.

Advantageously, at least part of the fall may be or substantially be vertical in-use.

A vertical fall proximal to the liquid inlet allows for more effective remixing of vapour and liquid-gas phase components. This therefore allows more rapid subsequent vapourisation and remixing. Off-vertical components of the fall may be provided, however, as long as no vapour trap is present.

Beneficially, the method may further comprise the step of heating the vapourised liquefied natural gas in the liquefied natural gas vapouriser to promote remixing.

Heating the vapourised liquefied natural gas would promote remixing and thereby increase the likelihood that the liquefied natural gas that reaches the vapour outlet is representative of the source of the liquefied natural gas.

According to a second aspect of the invention, there is provided a liquefied natural gas vapouriser, preferably specifically adapted for use with a method according to the first aspect of the invention, the vapouriser comprising: a vapouriser housing; a liquid inlet and a vapour outlet which are positioned in the vapouriser housing; a fluid transport conduit which extends between the liquid inlet and the vapour outlet inside the vapouriser housing, the fluid transport conduit including a vapourisation conduit portion and a heat exchange conduit, the vapourisation conduit portion being positioned immediately following the liquid inlet and having a fall thereacross; and a vapourisation element, such as an apertured plate, positioned at or adjacent to the liquid inlet, the flash vapourisation plate having a critical orifice through which liquefied natural gas can flash vapourise; wherein vapourised liquefied natural gas in the vapourisation conduit portion is buoyed against the fall so as to be directed against a flow direction of liquid or liquid-gas phase natural gas to encourage remixing of the vapourised liquid natural gas and liquid or liquid-gas phase natural gas.

Providing an initial fall in a vapouriser in the region in which vapourisation will occur allows for the effects of fractionation to be countered. Where a fall is present, the bubbles of more volatile components will naturally rise against the flow of falling liquid or liquid-gas phase natural gas, which encourages the remixing effect prior to full vapourisation of the whole sample in the vapourisation conduit portion.

Preferably, at least one heating element associated with the fluid transport conduit may be provided to directly or indirectly heat vapourised liquid natural gas.

Heating of the natural gas ensures that complete vapourisation is effected, further mitigating the effects of fractionation of the sample in the vapouriser.

In a preferable embodiment, there is a lower pressure in the fluid transport conduit than outside the liquid inlet thereby encouraging flash vapourisation across the vapourisation plate.

A lower pressure in the in use fluid transport conduit is required in order for flash vapourisation of the liquefied natural gas to occur upon passing through the vapourisation plate. Flash vapourisation provides the advantage that more of the components vapourise at the same time and so the analyte that reaches the vapour outlet more fully compositionally represents the source of the liquefied natural gas than a situation with a more gradual vapourisation process.

Additionally, at least part of the fall may be or substantially be vertical.

A vertical section proximal to the liquid inlet allows for the less volatile unvapourised components to more rapidly and directly descend through the fluid transport conduit counter to the direction of the rising bubbles of volatile early-vapourised components than if the section of fluid transport conduit proximal to the liquid inlet were not vertical. This therefore allows more rapid subsequent vapourisation and remixing.

Beneficially, the temperature inside the in use fluid transport conduit may be greater than that of the liquefied natural gas outside the liquid inlet.

In order to allow the temperature of the vapourised sample to increase to an ambient temperature, and to encourage remixing of the unvapourised components with the vapourised components, the temperature inside the fluid transport conduit should be greater than that of the liquefied natural gas outside the liquid inlet.

Optionally, the heat exchange conduit may be formed so as to have a circuitous, tortuous or serpentine path.

A circuitous, tortuous or serpentine path allows for a greater length of fluid transport conduit to be located within an area. This allows for a more compact arrangement of the fluid transport conduit and so the liquefied natural gas vapouriser takes up less space. Additionally, this arrangement may allow for a greater length of fluid transport conduit to be located within an area which is heated by any given heating element.

Additionally, the circuitous, tortuous or serpentine path may contain a plurality of turns.

The plurality of turns allow for a compact arrangement of the circuitous, tortuous or serpentine path.

Preferably, the plurality of turns may or may be substantially U-shaped.

The turns being substantially U-shaped also allow for a compact arrangement of the circuitous, tortuous or serpentine path.

In a preferable embodiment, the vapouriser housing may enclose the fluid transport conduit.

The vapouriser housing enclosing the fluid transport conduit may provide a space for the storage of components necessary for the operation of the liquefied natural gas vapouriser. Furthermore, the enclosing vapouriser housing can provide insulation or means for including insulation for the heating elements or the liquefied natural gas within the fluid transport conduit. Additionally, the vapouriser housing can increase safety by providing a barrier between or at the fluid transport conduit, which may be at a temperature which is low or high enough to cause harm to personnel, and personnel.

Preferably, the fluid transport conduit, liquid inlet, vapour outlet and flash vapourisation plate may be formed of austenitic stainless steel.

The formation of these components from stainless steel prevents or limits their corrosion by corrosive elements contained within the liquefied natural gas. Austenitic stainless steel has a higher work of fracture at low temperature than other types of stainless steels and so is appropriate for use in this device which may be exposed to temperatures of −168° C. Alternatively, materials with higher thermal conductivity, such as copper, a copper alloy, Inconel, and/or Monel, for example, may be considered.

Preferably, the fluid transport conduit, liquid inlet, vapour outlet and flash vapourisation element or plate are formed of copper or copper alloy.

Copper and its alloys are better thermal conductors than many other conventional engineering materials whilst remaining ductile at cryogenic temperatures and thus is suitable for use in this application which may require the transfer of heat through the walls of the fluid transport conduit. Additionally, steel of 9% or more nickel may be used to provide additional strength whilst maintaining the desired ductility.

Beneficially, the liquid inlet may be positioned on a side surface of the vapouriser housing.

Positioning the liquid inlet on the side surface of the housing would prevent or limit liquefied natural gas from pouring through the liquid inlet under the influence of gravity, if this was no longer wanted. Additionally, positioning on the side surface of the housing may allow for easier access of pipework to the liquid inlet.

Alternatively the liquid inlet may be positioned on a top surface of the vapouriser housing.

Positioning the liquid inlet on a top surface of the housing allows for the source of the liquefied natural gas to fall rapidly and directly downwards into the liquid inlet without significant change in pressure or premature heat gain.

Preferably, at least part of a width of the fluid transfer conduit may be equal to or larger than a typical bubble size of vapourised liquid natural gas in the vapourisation conduit portion. In this case, at least part of a width of the fluid transfer conduit may optionally be greater than the typical bubble size of vapourised liquid natural gas in the vapourisation conduit portion.

If a width of the fluid transfer conduit, and preferably at least the vapourisation conduit portion, is close to or slightly larger than a bubble size of the vapour, then the greatest contact is provided between falling liquid or liquid-gas phase natural gas and the rising bubbles, since the liquid or liquid-gas phase natural gas has room to contact with the sides of the bubbles, but not so much room as to completely avoid contact with the vapour. This further improves the efficiency of remixing.

Advantageously, the liquefied natural gas vapouriser may further comprise a pipeline adaptor for connecting to a pipeline carrying liquefied natural gas to be sampled.

Providing a pipeline adaptor can allow for the liquefied natural gas vapouriser to be attached to a corresponding pipeline in a more efficient manner than if there were not a pipeline adaptor included. A pipeline adaptor can be beneficial in the instance that the pipeline has a differing diameter of the tube to the fluid transport conduit of the vapouriser. This insures that the invention can be installed effectively.

According to a third aspect of the invention, there is provided a system for vapourising liquefied natural gas from a pipeline including a liquefied natural gas vapouriser, preferably in accordance with the second aspect of the invention; and a pipeline having a circular cross-section and connecting to the liquefied natural gas vapouriser via a pipeline adaptor wherein the pipeline is elevated relative to a vapour outlet.

In use, the liquefied natural gas vapouriser requires a source of liquefied natural gas and a pipeline able to transport and supply the gas.

The invention will now be more particularly described by way of example only, with reference to the accompanying drawings, in which:

FIG. 1 is a diagrammatic cross-sectional view of a portion of a conventional or known liquefied natural gas vapouriser, in accordance with the state of the art, where the vapour outlet is elevated relative to a liquid input;

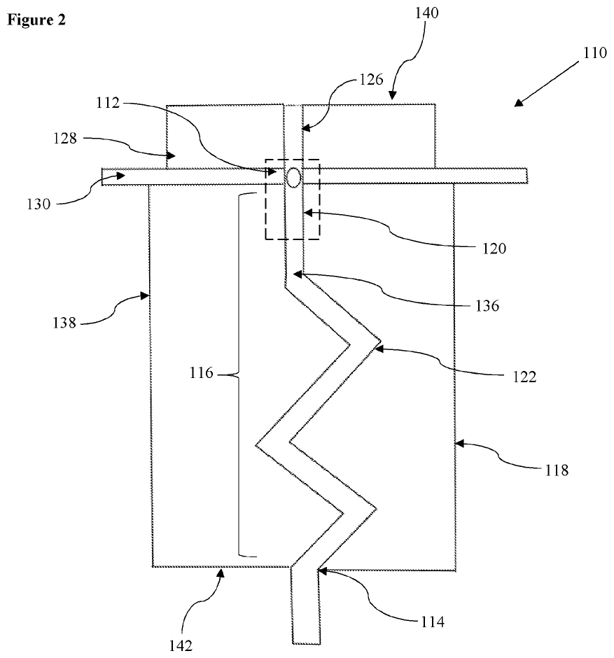

FIG. 2 is a side cross-sectional representation of one embodiment of a liquid vapouriser, in accordance with the second aspect of the present invention;

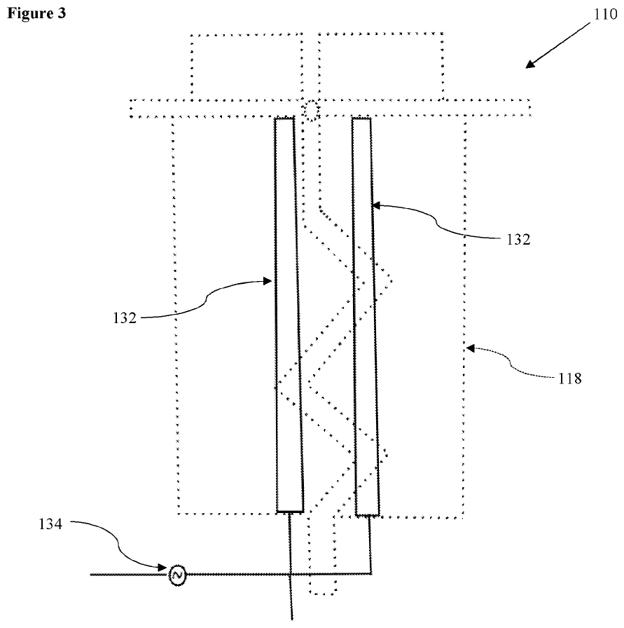

FIG. 3 is a further cross-sectional representation of the liquid vapouriser of FIG. 2, indicating the positions of heating elements for the heat exchange conduit;

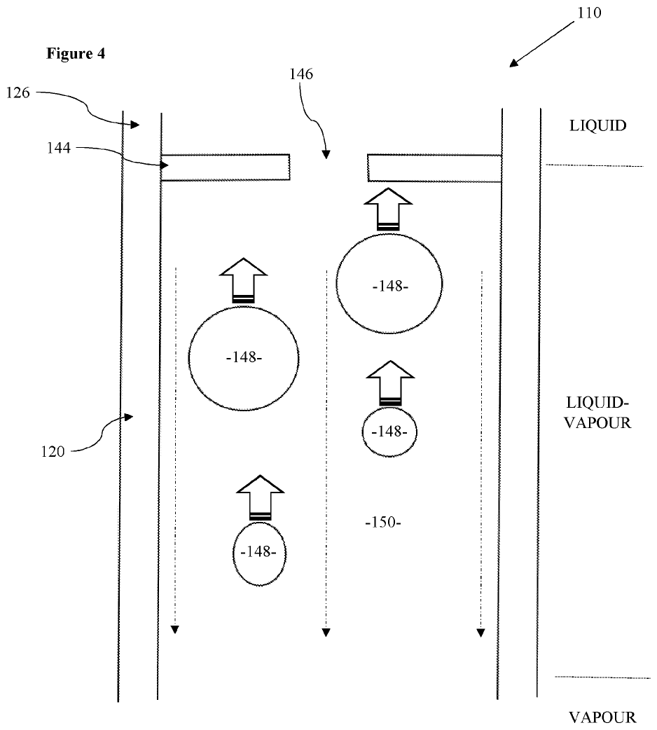

FIG. 4 shows an enlarged cross-sectional representation of the dashed portion of the liquid vapouriser indicated in FIG. 2; and

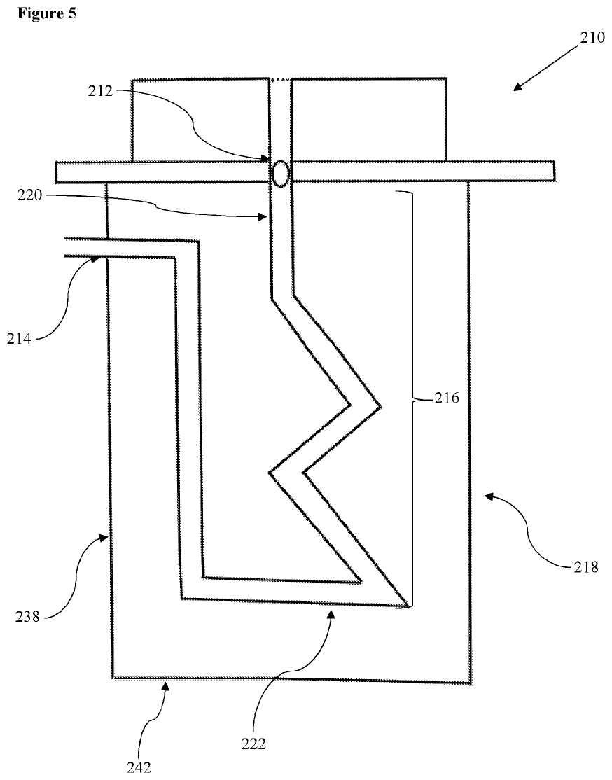

FIG. 5 shows a side cross-sectional representation of a second embodiment of a liquid vapouriser, in accordance with the second aspect of the present invention.

Referring to FIG. 2 of the drawings, there is shown a first embodiment of a liquid vapouriser 110, in which a liquid inlet 112 is elevated relative to a vapour outlet 114.

Identical and/or similar components to those described in the context of the prior art will be referred to using identical and/or similar reference numerals with ‘100’ added, and further detailed description will be omitted for brevity.

In particular, the vapourisation conduit portion 120 is vertical or substantially vertical extending from the liquid inlet, such that a flow path of the liquefied natural gas passing therethrough is directed along a fall prior to entering into the heat exchange conduit 122. The liquid inlet 112 may be directly vertically above the vapour outlet 114, but this is not a strict requirement; the position of the vapourisation conduit portion 120, that is, the portion of the vapouriser in which the complete phase change from liquid to gas occurs, must include a fall or drop in order to produce the inventive results. Preferably, the fall is vertical or substantially vertical. It will, however, be apparent that, provided there are no vapour traps in the vapourisation conduit portion 120, the fall could include some diagonal or horizontal aspect as well as a vertical component, or indeed could be in part arcuate.

The liquefied natural gas vapouriser 110 comprises the liquid inlet 112, the vapour outlet 114, and a fluid transport conduit 116 which interconnects two ends thereof disposed inside a vapouriser housing 118. The fluid transport conduit 116 may have a plurality of different portions or sections; in the depicted embodiment the conduit 116 has the vapourisation conduit portion 120 which extends into the vapouriser housing 118 from the liquid inlet 112, and at least a portion of the vapourisation conduit portion 120 being vertically aligned or substantially vertically aligned so as to create a fall thereacross. A main body of the vapouriser housing 118 may be provided as a heat conducting source, such as a thermally conductive metal, so as to improve heat exchange therein.

In order to avoid heat loss through the liquid inlet 112 prior to entry into the vapouriser 110, an inlet conduit 126 to the vapouriser 110 may be provided so as to include thermal insulation therearound, such as the insulating element 128 indicated. This thermal insulation could be provided as insulating foam, such as polyurethane or polyisocyanurate foam. Other insulators, such as cellular glass, could also be considered. An insulator plate 130 may also be provided for the vapouriser housing 118 at or adjacent to the liquid inlet 112 so as to limit heat transfer between the inside of the vapouriser housing 118 and the exterior of the vapouriser 110.

The fluid transport conduit 116 may also include a heat exchanger conduit 122, which may preferably have a circuitous, tortuous or serpentine path whereby the fluid transport conduit 116 follows a series of approximately U-shaped turns 124. Although these turns are depicted as U-shaped, they may also be V-shaped or any other suitable shape whereby the path of the fluid transport conduit is such that it approximately reverses in direction. Any number of U-shaped turns 124 may be used to achieve this circuitous, tortuous or serpentine path. The shape of the heat exchange conduit 122 is primarily designed to encourage efficient thermalisation through the vapouriser 110; however, thermalisation could be achieve by the provision of additional heat exchangers, such as radiator fins.

Furthermore, thermalisation can be improved by the provision of one or more heating elements 132, such as those indicated in FIG. 3. Here, two heating elements 132 are provided which may be in direct or indirect thermal contact with the heat exchange conduit 120. These heating elements 132 are provided as electric heating elements which are powered by an external power source 134. Any appropriate heating element could be provided however, such as an induction heater or a thermal liquid jacket, and such modifications will be apparent to the skilled person.

The or each heating element 134 is preferably positioned so as to heat at least a portion of the length of the fluid transport conduit 116, and preferably a majority or full extent of the heat exchanger conduit 122. This positioning can be achieved by the heating elements 134 being wrapped around the length of the vapouriser housing 118. Alternatively, the positioning can be achieved by the heating elements 134 being wrapped around the length of the heat exchanger conduit 122 in a helical fashion or can be achieved by discrete heating elements 134 being placed proximally within, or outside, the housing 118. The positioning of the heating elements 134 may therefore be such that they are between the liquid inlet 112 and vapour outlet 114 along a vertical axis of the liquefied natural gas vapouriser 110.

These heating elements 134 may be akin to radiators taking the form of conduits carrying a fluid with a temperature greater than the temperature of the environment external to the heating element. Alternatively, the heating elements may be coils, strips or ribbons of materials with an electric current passing through the material which causes resistive heating. They may be made of metal, such as nichrome, kanthal, or cupronickel; an intermetallic, such as molybdenum disilicide; or a ceramic, such as barium titanate.

This circuitous, tortuous or serpentine path has the effect that the heat exchange conduit 122 in between an end 136 of the vapourisation conduit portion 120 and the vapour outlet 114 is greater than if the heat exchange conduit 122 followed a path directly between the two points. In use, this has the result that the vapour travelling from the liquid inlet 112 to the vapour outlet 114 spends a greater length of time within the heat exchange conduit 122 than would be the case if the path was straight. Alternatively, the heat exchange conduit 122 may follow a helical path between the end 136 of the vapourisation conduit portion 120 and the vapour outlet 114 or an irregularly curved path or any other path such that the length of the heat exchange conduit 122 is greater in between the end 136 of the vapourisation conduit portion 120 and the vapour outlet 114 than if the path was straight.

The vapouriser housing 118 may preferably be formed so as to enclose a width or diameter of the path of the fluid transport conduit 116. This vapouriser housing 118 is preferably a straight tube with a circular cross-section, although other cross-sections such as rectangular can be used, preferably having at least one in-use side surface 138, a top surface 140 and a bottom surface 142.

As shown in FIG. 2, the liquid inlet 112 is positioned at or adjacent to the top surface 140 of the vapouriser housing 118 whilst the vapour outlet 114 is positioned at or adjacent to the bottom surface 142 of the vapouriser housing 118. This allows the liquefied natural gas to be directed along a fall between the liquid inlet 112 and vapour outlet 114, and ensures that the vapourisation conduit portion 120 also includes a fall.

Whilst direct heating of the heat exchange conduit 122 may be possible, it may alternatively be possible to provide one or more supplementary heat exchangers in contact with the heat exchange conduit, with the heating elements 134 being used to indirectly provide a heating effect to the liquefied natural gas in the heat exchange conduit.

At or adjacent to the liquid inlet 112, and inside the vapouriser housing 118, there is positioned a flash vapourisation element, in this case a plate 144 or other suitably thin strip, mesh or layer, which spans the fluid transfer conduit 116 at or adjacent to the liquid inlet 112. Positioned in or substantially in the centre of the flash vapourisation plate 144 is an aperture which defines a critical orifice 146. Although this critical orifice 146 is depicted as a centrally positioned single aperture in the flash vapourisation plate 144, the critical orifice 146 may be positioned anywhere in the flash vapourisation plate 144, and could alternatively comprise a plurality of spaced apart apertures.

The fluid transport conduit 116, liquid inlet 112, vapour outlet 114 and flash vapourisation plate 144 may be formed from a low temperature and corrosion resistant material such as austenitic stainless steel. Alternatively, they may be formed from copper or an alloy of copper, Inconel, and/or Monel, for example.

In use, a source of liquefied natural gas, which may be a sample from a piping network which carries liquefied natural gas, is connectively positioned adjacent to and below the liquid inlet 112. There is a substantially lower pressure within the fluid transport conduit 116 than outside the liquid inlet 112. This causes the flow of the liquefied natural gas to be directed through the liquid inlet 112 and then through the flash vapourisation plate 144 via the critical orifice 146. The rate of flow of the liquid increases as the liquid passes through the critical orifice 146 due to the principle of the conservation of mass. The Venturi effect may cause the pressure of the liquefied natural gas beyond the critical orifice 146 to decrease to the point whereby the more volatile components of the liquefied natural gas are not stable in liquid form and subsequently flash vapourise. The full transition between the liquid and gas phases of the natural gas therefore occurs inside the vapourisation conduit portion 120, which defines the flow path having a fall.

Due to the fall inside the vapourisation conduit portion 120, the natural gas which remains in the liquid phase or liquid-gas transition phase will run down the vapourisation conduit portion under the effect of gravity. On the other hand, vapourised volatile components of the natural gas will rise back up the vapourisation conduit portion 120 due to their natural buoyancy. This will encourage remixing of the various components which are close to the liquid-gas phase boundary. Remixing of the components will thereby significantly reduce or even eliminate fractionation of the sample in the eventual vapour phase once passed through the end 136 of the vapourisation conduit portion 120, through the heat exchange conduit 122 and out of the vapour outlet 114. This process is illustrated in FIG. 4 in detail. The vapour bubbles 148 are buoyed in the sampled liquid natural gas 150 which is being directed along the fall under gravity. The broad arrows indicate the direction of movement of the bubbles 148, whereas the dashed arrows indicate the direction of flow of the sampled liquid or liquid-gas phase natural gas 150. Remixing will therefore be encouraged as the two disparate phases come into contact with one another.

It is noted that the fluid transport conduit 116, and in particular the vapourisation conduit portion 120 could be sized and shaped so as to improve the remixing effect between vapour bubbles 148 and the sampled liquid natural gas 150. If the width of the fluid transport conduit 116 and/or vapourisation conduit 120 is similar in size, and more preferably slightly larger than a typical vapour bubble size of the more volatile components, this will improve the contact between a vapour bubble 148 and the sampled liquid natural gas 150 in the vapourisation conduit portion 120 as they travel in opposing directions therethrough.

A pressure difference across the fluid transport conduit 116 exists between the liquid inlet 112 and the vapour outlet 114, with there being a lower pressure in the fluid transport conduit 116 proximal to the liquid inlet 112 than there is proximal to the vapour outlet 114. The vapourised components are thereby encouraged to travel along the length of the heat exchange conduit 122 following exit from the end 136 of the vapourisation conduit portion 120 and are preferably heated by the heating elements 134 which may be preferably positioned along the length of the fluid transport conduit 116. Once these vapourised components have reached the vapour outlet 114, they are then analysed, by external analytical equipment, with the aim of determining a composition of the liquefied natural gas within the liquid source.

Since the components of liquefied natural gas which immediately flash vapourised were buoyed back up the vapourisation conduit portion 120 against the downward flow of unvapourised liquid, remixing will be promoted, and the components which are analysed will be a more representative sample than in an alternative arrangement.

The liquefied natural gas vapouriser 110 as previously described can be used as part of a system, in combination with a pipeline, for the vapourisation of liquefied natural gas. In this instance the pipeline would be elevated relative to the vapour outlet 114.

A second embodiment of a liquefied natural gas vapouriser is indicated in FIG. 5, and is indicated globally at 210. Identical and/or similar reference numerals to those used in connection with the first embodiment will be used to refer to identical and/or similar components, and further detailed description will be omitted for brevity.

In this embodiment, the liquid inlet 212 extends into the fluid transport conduit 216 via the vapourisation conduit portion 220. A fall is provided across the vapourisation conduit portion 220 which encourage the remixing effect as described above.

However, in this embodiment, the path of the heat exchange conduit 222 is such that the path followed extends back up on itself inside the vapouriser housing 218, with the vapour outlet 214 extending out of the vapouriser housing 218 through a side surface 238 thereof, rather than the bottom surface 242 of the vapouriser housing 218.

In addition to the above-described embodiments, it will be appreciated that a pipeline adaptor could be fixed to the liquid inlet and/or vapour outlet, so that the liquefied natural gas vapouriser can be efficiently operatively connected to a corresponding pipeline. This adaptor may take the form of a coupler, reducer or any other fitting which allows two pipelines to be connected together.

Whilst the described liquefied natural gas vapouriser describes a fluid transport conduit with a circuitous, tortuous or serpentine path, the path of the fluid transport conduit between the vertical sections can be straight.

Although the above described liquefied natural gas vapouriser describes an arrangement whereby flash vapourisation occurs when the liquefied natural gas travels beyond a flash vapourisation plate which is associated with the liquid inlet, it is appreciated that flash vapourisation is not necessary for the invention to function. The advantage of the invention remains apparent if the liquefied natural gas vapourises more gradually as long as components of the liquefied natural gas vapourise at different rates or under different conditions, provided that vapourisation occurs over a fall.

Whilst the above described liquefied natural gas vapouriser is positioned such that the liquid inlet is directly above the vapour outlet, it will be appreciated that the liquid inlet and vapour outlet may be offset from one another with respect to a horizontal axis and thereby not be vertically directly above one another.

Although the above liquefied natural gas vapouriser is described as having heating elements that are between the liquid inlet and vapour outlet on a vertical axis, and thus entirely below the liquid inlet, the heating elements may in fact be entirely above both of the liquid inlet and the vapour outlet.

It is therefore possible to provide a method of vapourising a sample of liquefied natural gas so as to retain or substantially retain the proportions of components of the liquefied natural gas by introducing liquefied natural gas into a liquid inlet with the liquid inlet being elevated relative to a vapour outlet. The liquefied natural gas is then flash vapourised and directed along a fall from the liquid inlet to the vapour outlet, thereby encouraging any unvapourised liquefied natural gas to remix with the vapourised liquefied natural gas under gravity.

It is also therefore possible to provide a liquefied natural gas vapouriser comprising a liquid inlet elevated relative to a vapour outlet. A fluid transport conduit connects the liquid inlet and the vapour outlet and a flash vapourisation plate is associated with the liquid inlet with least one heating element positioned so as to heat the fluid transport conduit.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. A method of vapourising a sample of liquefied natural gas so as to retain or substantially maintain the proportions of components of the liquefied natural gas on vapourisation, the method comprising the steps of:
a. introducing liquefied natural gas into a liquid inlet of a liquefied natural gas vapouriser;
b. vapourising the liquefied natural gas at a vapourisation element at or adjacent to the liquid inlet; and
c. directing vapourised liquefied natural gas into a vapourisation conduit portion directly after the liquid inlet, the vapourisation conduit portion having a fall, thereby encouraging vapourised liquid natural gas to be directed against a flow direction of liquid or liquid-gas phase natural gas in the vapourisation conduit portion to encourage remixing of the vapourised liquid natural gas and liquid or liquid-gas phase natural gas.

2. The method as claimed in claim 1, further comprising a step d, subsequent to step c, of passing vapourised liquid natural gas into a heat exchange conduit immediately after the vapourisation conduit portion.

3. The method as claimed in claim 2, wherein a flow path through the heat exchange conduit follows a circuitous, tortuous or serpentine path through the liquefied natural gas vapouriser.

4. The method as claimed in claim 1, wherein, during step c, at least part of the fall is or is substantially vertical in use.

5. The method as claimed in claim 1, further comprising the step of heating the vapourised liquefied natural gas in the liquefied natural gas vapouriser to promote remixing.

6. A liquefied natural gas vapouriser comprising:
a vapouriser housing;
a liquid inlet and a vapour outlet which are positioned in the vapouriser housing;
a fluid transport conduit (116) which extends between the liquid inlet and the vapour outlet inside the vapouriser housing, the fluid transport conduit including a vapourisation conduit portion and a heat exchange conduit, the vapourisation conduit portion being positioned immediately following the liquid inlet and having a fall thereacross; and
a vapourisation element positioned at or adjacent to the liquid inlet (112, 212), the vapourisation element having a critical orifice which leads into the vapourisation conduit portion; and
wherein vapourised liquefied natural gas in the vapourisation conduit portion is buoyed against the fall so as to be directed against a flow direction of liquid or liquid-gas phase natural gas to encourage remixing of the vapourised liquid natural gas and liquid or liquid-gas phase natural gas.

7. The liquefied natural gas vapouriser as claimed in claim 6, further comprising at least one heating element associated with the fluid transport conduit to directly or indirectly heat vapourised liquid natural gas.

8. The liquefied natural gas vapouriser as claimed in claim 6, wherein in use there is a lower pressure in the fluid transport conduit than outside the liquid inlet thereby encouraging flash vapourisation across the vapourisation element.

9. The liquefied natural gas vapouriser as claimed in claim 6, wherein at least part of the fall is or is substantially vertical.

10. The liquefied natural gas vapouriser as claimed in claim 6, wherein the temperature inside the fluid transport conduit is greater than that of the liquefied natural gas outside the liquid inlet.

11. The liquefied natural gas vapouriser as claimed in claim 6, wherein the heat exchange conduit is formed so as to have a circuitous, tortuous or serpentine path.

12. The liquefied natural gas vapouriser as claimed in claim 11, wherein the circuitous, tortuous or serpentine path contains a plurality of turns.

13. The liquefied natural gas vapouriser as claimed in claim 6, wherein the vapouriser housing encloses the fluid transport conduit.

14. The liquefied natural gas vapouriser, as claimed in claim 6, wherein the fluid transport conduit, liquid inlet, vapour outlet and flash vapourisation element are formed from any of or a combination of: austenitic stainless steel; copper; copper alloy; Inconel; and/or Monel.

15. The liquefied natural gas vapouriser as claimed in claim 6, wherein the liquid inlet is positioned on a side surface of the vapouriser housing.

16. The liquefied natural gas vapouriser as claimed in claim 6, wherein the liquid inlet is positioned on a top surface of the vapouriser housing.

17. The liquefied natural gas vapouriser as claimed in claim 6, further comprising a pipeline adaptor for connecting to a pipeline carrying liquefied natural gas to be sampled.

18. The liquefied natural gas vapouriser as claimed in claim 6, wherein at least part of a width of the fluid transfer conduit is equal to or larger than a typical bubble size of vapourised liquid natural gas in the vapourisation conduit portion.

19. The liquefied natural gas vapouriser as claimed in claim 18, wherein at least part of a width of the fluid transfer conduit is greater than the typical bubble size of vapourised liquid natural gas in the vapourisation conduit portion.

20. A system for vapourising liquefied natural gas from a pipeline including a liquefied natural gas vapouriser as claimed in claim 6; and a pipeline having a circular cross-section and connecting to the liquefied natural gas vapouriser via a pipeline adaptor wherein the pipeline is elevated relative to a vapour outlet.
